(19) United States
(12) Patent Application Publication
(10) Pub. No.: US 2025/0231839 A1
(43) Pub. Date: Jul. 17, 2025

(54) SMART PREFETCHING OF OPERATIONS TECHNIQUE

(71) Applicant: Nutanix, Inc., San Jose, CA (US)

(72) Inventors: Ajaykumar Rajubhai Bhammar, Bhavnagar (IN); Akshay Pandita, Jammu and Kashmir (IN); Angshuman Bezbaruah, Redmond, WA (US); Brajesh Kumar Shrivastava, Rohtas (IN); Manan Shah, Newark, CA (US); Abhishek Gupta, Uttar Pradesh (IN)

(21) Appl. No.: 18/677,339

(22) Filed: May 29, 2024

(30) Foreign Application Priority Data
Jan. 13, 2024 (IN) 202441002702

(51) Int. Cl. G06F 11/14

(52) U.S. Cl. CPC G06F 11/1451

(57) ABSTRACT

A smart prefetching of operations technique prefetches metadata and/or data of objects stored in a multi-cloud snapshot technology (MST) service associated with an object store. One or more data objects (e.g., an application) at a primary site may be designated for backup or failover to a secondary site, e.g., in the event of failure of the primary site. Smart prefetching logic of the MST is configured to prefetch the object metadata and/or object data from the object store to serve subsequent requests without accessing the object store. To that end, when storing data to the object store as one or more objects, MST maintains specific metadata along with the data of the objects. The technique utilizes the specific metadata to prefetch the object metadata and/or object data before receiving actual read requests for that data to improve the read latency and throughput when restoring the application as soon as possible.

### CROSS-REFERENCE TO RELATED APPLICATION

The present application claims the benefit of India Provisional Patent Application Serial No. 202441002702, which was filed on Jan. 13, 2024, by Ajaykumar Rajubhai Bhammar et al. for SMART PREFETCHING OF OPERATIONS TECHNIQUE, which is hereby incorporated by reference.

### BACKGROUND

### Technical Field

The present disclosure relates to data failover and, more specifically, to prefetching failover data in a data replication environment.

### Background Information

Data failover generally involves copying or replicating data among multiple datacenters to enable continued operation of data processing operations in a data replication environment, such as disaster recovery. In the event of a disaster, it is desirable to restore the failover data (e.g., an application) as soon as possible to reduce application down time. However, restoring data for latency sensitive applications may not meet failover requirements as the time to restore the data is too long. Hence there is a need for a technique to restore data for applications that cannot tolerate very high latency.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a block diagram of a controller virtual machine of the virtualization architecture;

FIG. 4 is a block diagram of a multi-site data replication environment configured for use in various deployments;

FIG. 5 is a block diagram of an exemplary data replication environment;

FIG. 6 is a block diagram of an exemplary workflow for fetching data from an object store;

FIG. 7 is a block diagram of an improved workflow for fetching data from an object store in accordance with a smart prefetching of operations technique; and

FIG. 8 is a block diagram of an exemplary heuristic constructed by the smart prefetching of operations technique.

### OVERVIEW

The embodiments described herein are directed to a smart prefetching of operations technique configured to prefetch metadata and/or data of objects stored in a repository service, such as a multi-cloud snapshot technology (MST) service associated with a public cloud object store. One or more data objects (e.g., an application executing in a user virtual machine) at a primary site may be designated for backup or failover to a secondary site, e.g., in the event of failure of the primary site in a multi-site data replication environment. Illustratively, smart prefetching logic of the MST is configured to prefetch the object metadata and/or object data from the object store (i.e., in advance of client requests to read the data) to obviate (avoid) or reduce object store accesses when serving subsequent read requests to thereby reduce latency in servicing those subsequent requests. To that end, when storing data to the object store as one or more objects, a data service of the MST maintains specific metadata along with the data of the objects. The technique utilizes the specific metadata to prefetch the object metadata and/or object data before receiving subsequent read requests for that data to improve the read latency and throughput when restoring (bringing up) the application as soon as possible. Notably, the technique builds (constructs, amends, or modifies) one or more heuristics pertaining to a range of data/metadata changes, e.g., a “change region” application programming interface (API).

As used herein, the multi-site data replication environment includes two or more datacenters, i.e., sites, which are often geographically separated by relatively large distances and connected over a communication network, e.g., a wide area network. For example, failover data at a local datacenter (primary site) may be replicated as a snapshot of a recovery point (RP) over the network to one or more remote datacenters located at geographically separated distances to ensure continued data processing operations in the event of a failure of the primary site. To initiate a full or incremental restore of the application (data) replicated as a RP, a client initially issues the change region API request to a data service of the MST to compute (determine) changes or differences (diffs) to a data object (the RP) and then fetches the data. In case of a full restore, computing the diffs beforehand helps the client avoid fetching “zeros changed regions” (regions that have zeroed data as a result of being overwritten as zeroes or at initialization) from the object store. Also, computing the diffs beforehand helps pull only non-zero changed regions (regions with non-zero data that have been overwritten) for an incremental restore. An index (e.g., Btree) manager of MST provides the changed region APIs to compute the diffs with or without metadata. When a compute diff request with metadata is issued, the Btree manager provides the requested metadata such as object identifier (ID) and object range (e.g., offset and length) along with the changed regions.

According to the technique, when a client issues a request to MST for only changed regions of one or more objects in a RP (i.e., compute diffs without metadata), the data service of MST internally translates the changed regions API request to a request to compute the differences with metadata. The translated request is forwarded to the Btree manager, which computes the diffs for the changed regions. The data service then returns the changed regions (associated with changed data from the object store) to the client. Notably, the data service also builds a heuristic (algorithm) using the additional (specific) metadata (e.g., object ID and object range) returned from the Btree manager to predict subsequent read requests and, thus, fetch the object metadata and object data in advance. Notably, unlike traditional caching techniques that determine cache entry replacement based on a policy in response to data access requests, the heuristic decides when to fetch object data based on recent usages and patterns independent of responding to actual data access requests. When the client subsequently issues a next request to fetch the data after receiving the changed regions, the data service of MST has already fetched the object metadata and its associated data in advance, which substantially reduces the latency to retrieve (read) the data because there is no inline cost to read the object metadata and object data along with the read request. The smart prefetching technique thus facilitates fast recovery of data by increasing the restore throughput to enable fast instantiation (bringing up) of an application to meet, e.g., disaster recovery requirements.

The technique provides several advantages, such as substantial reduction in latency in data read requests, substantial reduction in cost every time the read request is made to public cloud object storage, and faster data restoration or recovery during failover or disaster scenarios. The smart prefetching technique thus speeds up data restore by fetching object metadata and data in advance without extra cost. The heuristic decides when to fetch object metadata and data based on recent usages and patterns, such as predicting read requests based on results from change region API requests. That is, the technique dynamically decides whether and when to fetch, e.g., in advance, object metadata and object data or just object metadata depending on the current load in the system and other heuristics independent of responding to actual data access requests. In this manner, the technique may fetch data not used to respond to a current data access request but is predicted to be needed in a subsequent request and may be fetched at any time prior to the predicted need. Notably, this aspect of the technique is unlike traditional caching techniques that fetch data and additional data (presumably needed) according to a policy in response to a specific data access request. The technique also benefits accessing data for passive statistics gathering and analytics. The policy may be based on a consumption model of the data by the client, e.g., a client workflow is predicted to consume use of a data object after accessing it a certain number of times. In sum, the technique reduces the disaster recovery time objective by improving restore throughput.

### Description

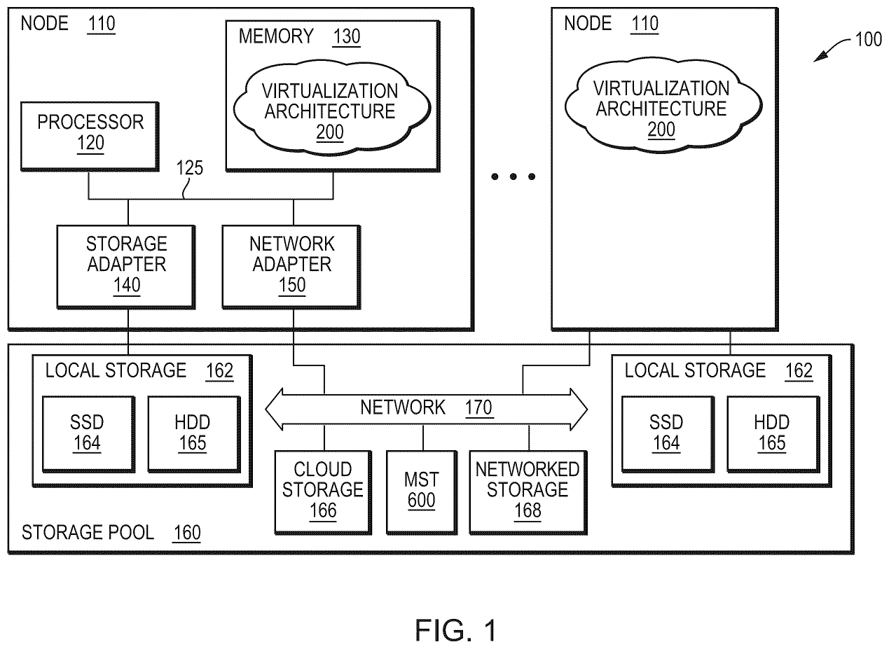

FIG. 1 is a block diagram of a plurality of nodes 110 interconnected as a logical or physical grouping such as, e.g., a cluster 100, and configured to provide compute and storage services for information, e.g., data and metadata, stored on storage devices of a virtualization environment. Each node 110 is illustratively embodied as a physical computer having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster-wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over network 170, which is illustratively an Ethernet local area network (LAN). The network adapter 150 may thus be embodied as a network interface card having the mechanical, electrical and signaling circuitry needed to connect the node 110 to the network 170. The multiple tiers of SOCS include storage that is accessible through the network 170, such as cloud storage 166 and/or networked storage 168, as well as the local storage 162 within or directly attached to the node 110 and managed as part of the storage pool 160 of storage objects, such as files and/or logical units (LUNs). The cloud and/or networked storage may be embodied as network attached storage (NAS) or storage area network (SAN) and include combinations of storage devices (e.g., SSDs and/or HDDs) from the storage pool 160. A multi-cloud snapshot technology (MST 600) service of an archival storage system provides storage of large numbers (amounts) of point-in-time images or recovery points (i.e., snapshots) of application workloads on an object store, which may be part of cloud storage 166. Communication over the network 170 may be affected by exchanging discrete frames or packets of data according to protocols, such as the Transmission Control Protocol/Internet Protocol (TCP/IP) and the OpenID Connect (OIDC) protocol, although other protocols, such as the User Datagram Protocol (UDP) and the HyperText Transfer Protocol Secure (HTTPS), as well as specialized application program interfaces (APIs) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes and programs being embodied as logic, components, and/or modules consisting of hardware, software, firmware, or combinations thereof.

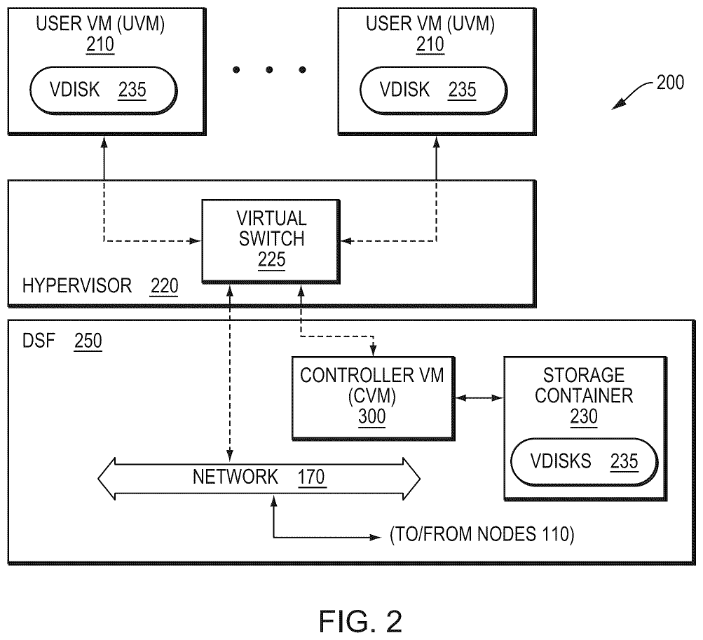

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 300, which functions as a virtual controller for SOCS. The CVMs 300 on the nodes 110 of the cluster 100 interact and cooperate to form a distributed system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyperconvergence architecture wherein the nodes provide both storage and computational resources available cluster wide.

The client software (e.g., applications) running in the UVMs 210 may access the DSF 250 using filesystem protocols, such as the network file system (NFS) protocol, the common internet file system (CIFS) protocol and the internet small computer system interface (iSCSI) protocol. Operations on these filesystem protocols are interposed at the hypervisor 220 and redirected (via virtual switch 225) to the CVM 300, which exports one or more iSCSI, CIFS, or NFS targets organized from the storage objects in the storage pool 160 of DSP 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 300 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 300 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CV NM 300 within the same node as the UV NM 210, then the IP-based storage protocol request is internally forwarded within the node to the CVM. The CVM 300 is configured and structured to properly interpret and process that request. Notably, the IP-based storage protocol request packets may remain in the node 110 when the communication—the request and the response—begins and ends within the hypervisor 220. In other embodiments, the IP-based storage protocol request may be routed by the virtual switch 225 to a CVM 300 on another node of the cluster 100 for processing. Specifically, the IP-based storage protocol request is forwarded by the virtual switch 225 to a physical switch (not shown) for transmission over network 170 to the other node. The virtual switch 225 within the hypervisor 220 on the other node then forwards the request to the CVM 300 on that node for further processing.

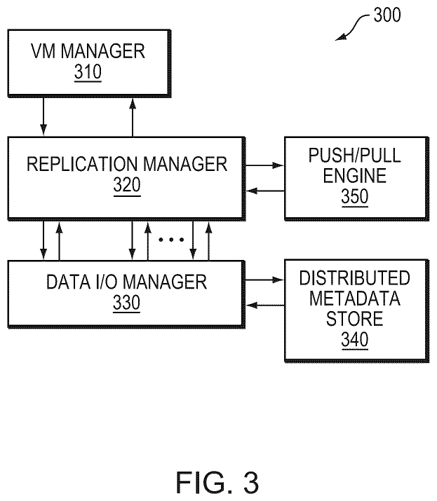

FIG. 3 is a block diagram of the controller virtual machine (CVM) 300 of the virtualization architecture 200. In one or more embodiments, the CVM 300 runs an operating system (e.g., the Acropolis operating system) that is a variant of the Linux® operating system, although other operating systems may also be used in accordance with the embodiments described herein. The CVM 300 functions as a distributed storage controller to manage storage and I/O activities within DSF 250 of the cluster 100. Illustratively, the CVM 300 runs as a virtual machine above the hypervisor 220 on each node and cooperates with other CVMs in the cluster to form the distributed system that manages the storage resources of the cluster, including the local storage 162, the networked storage 168, and the cloud storage 166. Since the CVMs run as virtual machines above the hypervisors and, thus, can be used in conjunction with any hypervisor from any virtualization vendor, the virtualization architecture 200 can be used and implemented within any virtual machine architecture, allowing the CVM to be hypervisor agnostic. The CVM 300 may therefore be used in a variety of different operating environments due to the broad interoperability of the industry standard IP-based storage protocols (e.g., iSCSI, CIFS, and NFS) supported by the CVM.

Illustratively, the CVM 300 includes a plurality of processes embodied as services of a storage stack running in a user space of the operating system of the CVM to provide storage and I/O management services within DSF 250. The processes include a virtual machine (VM) manager 310 configured to manage creation, deletion, addition and removal of virtual machines (such as UVMs 210) on a node 110 of the cluster 100, For example, if a UVM fails or crashes, the VM manager 310 may spawn another UVM 210 on the node. A replication manager 320 is configured to provide replication and disaster recovery capabilities of DSF 250. Such capabilities include migration/failover or failback of virtual machines and containers, as well as scheduling of snapshots. The replication manager 320a may interact with a push/pull engine 350 that includes logic configured to drive data and metadata seeding as described herein. In an embodiment, the push/pull engine 350 may be a service included as part of the replication manager 320 executing in the CVM 300. A data I/O manager 330 is responsible for all data management and I/O operations in DSF 250 and provides a main interface to/from the hypervisor 220, e.g., via the IP-based storage protocols. Illustratively, the data I/O manager 330 presents a vdisk 235 to the UVM 210 in order to service I/O access requests by the UVM to the DFS. A distributed metadata store 340 stores and manages all metadata in the node/cluster, including metadata structures that store metadata used to locate (map) the actual content of vdisks on the storage devices of the cluster.

In an embodiment, CVM 300, DSF 250 and MST 600 may cooperate to provide support for snapshots, which are point-in-time copies of protected entities, such as VMs, applications, workloads, files, and/or vdisks. For example, CVM 300, DSF 250 and MST 600 may cooperate to process a workload of an application (e.g., data) for local storage on a vdisk 235 of the cluster 100 (on-premises) as one or more generated snapshots that may be further processed for replication to an external repository. The replicated snapshot data may be backed up from cluster 100 to the external repository at the granularity of a vdisk. The external repository may be a backup vendor or, illustratively, cloud-based storage 166, such an object store.

In the event of a disaster, the application workload processed by a UVM of the primary site cluster 100 may fail over to the secondary site (e.g., a cloud cluster platform) and one or more instances of the cluster 100 with similar capabilities may be provisioned for recovery of the application on the cloud platform. Data failover or failback generally involves copying or replicating data among one or more nodes 110 of clusters 100 embodied as, e.g., datacenters to enable continued operation of data processing operations in a data replication environment, such as backup or disaster recovery. The data replication environment includes two or more datacenters, i.e., sites, some of which may be cloud sites such those operated by third-party cloud service providers or CSPs (e.g., Amazon Web Services, Microsoft Azure). These sites are typically geographically separated by relatively large distances and connected over a communication network, such as a WAN. For example, data at a local datacenter (primary site) may be replicated over the network to one or more remote datacenters, acting as repository sites (e.g., MST running on AWS or Azure) used for data recovery, located at geographically separated distances to ensure continuity of data processing operations in the event of a failure of the nodes at the primary site. In addition, one or more secondary sites may act as application recovery sites once data has been recovered from a repository site.

Illustratively, asynchronous (incremental) replication is employed between the sites using, for example, a point-in-time image replication from the primary site to the secondary site. Incremental replication generally involves at least two point-in-time images or snapshots of the data to be replicated, e.g., a common or “base” snapshot that is used as a reference and a current snapshot that is used to identify incremental changes to the data since the base snapshot. To facilitate efficient incremental replication in a multi-site data protection environment, a base snapshot is required at each site.

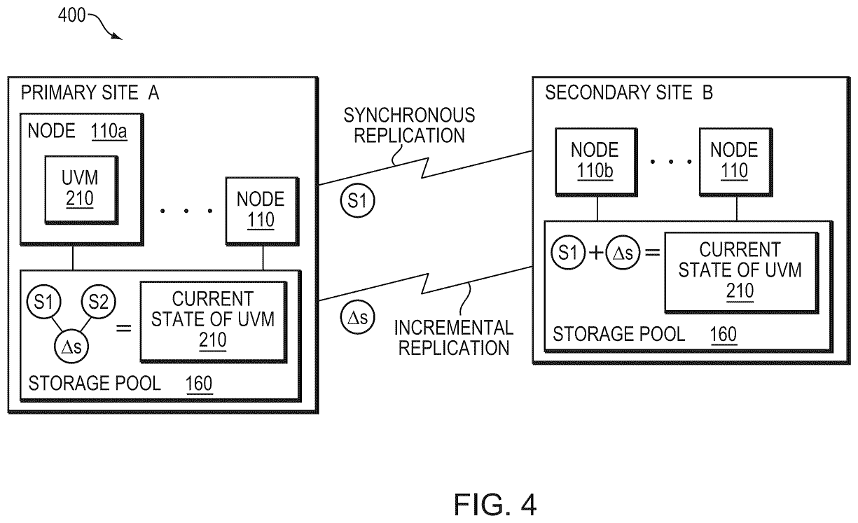

FIG. 4 is a block diagram of a multi-site data replication environment 400 configured for use in various deployments, such as for disaster recovery (DR). Illustratively, the multi-site environment 400 includes two sites: primary site A and secondary site B, wherein each site represents a datacenter embodied as a cluster 100 having one or more nodes 110. A category of data (e.g., one or more UVMs 210) running on primary node 110a at primary site A may be designated for failover to secondary site B (e.g., secondary node 110b) in the event of failure of primary site A. A first snapshot S1 of the data is generated at the primary site A and replicated (e.g., via synchronous replication) to secondary site B as a base snapshot S1. Subsequently, a second snapshot S2 may be generated at primary site A to reflect a current state of the data (e.g., UVM 210). Since the base snapshot S1 exists at sites A and B, incremental changes of the second snapshots S2 are computed with respect to the reference snapshot. Only the incremental changes (deltas Δs) to the data designated for failover need be sent (e.g., via asynchronous replication) to site B, which applies the deltas (Δs) to S1 so as to synchronize the (current) state of the UVM 210 to the time of the snapshot S2 at the primary site. A tolerance of how long before data loss will exceed what is acceptable determines (i.e., imposes) a frequency of snapshots and replication of deltas to failover sites.

Typically, the base snapshot captures data and metadata (configuration information) of a protected entity (e.g., the application processed by a UVM) at a primary site and is replicated to a secondary site as a recovery point (RP). That is, the captured data and metadata may include an entire state of the protected entity including associated storage objects. Thereafter, periodic incremental snapshots may be generated at the primary site and replicated as RPs to the secondary site. For example, in a backup deployment, a backup software component may be responsible for copying/archiving one or more RPs to cloud storage of a CSP. In a DR deployment, a DR software component may monitor the occurrence of a disaster/failure of the application at the primary site and spin-up (instantiate) the application on a secondary site using a RP that was replicated from the primary site. Once the provisioning is complete, the failover/failback data may be brought online on the remote site cluster using MST 600, which may be running on the cloud.

The smart prefetching technique described herein may apply to at least two data replication environments each using retrieval of data from external sources for recovery. The first environment is a DR environment where the CVM 300 (e.g., push/pull engine 350) cooperates with MST 600 to push data from a cluster to cloud storage (external repository) and, when necessary, pull data from the repository to the cluster. This DR environment enables seamless movement of data between an on-premises cluster (e.g., a primary site) and a cluster that is spun up in the cloud (e.g., a secondary site). The second environment is a data replication environment involving backup where data is periodically snapshotted and replicated to the external repository (object store) via MST and differential based (diff-based) data pulling (seeding) is employed to fetch data back from the object store via MST 600 in response to recovery from, e.g., a data corruption by a rogue application or a ransomware attack.

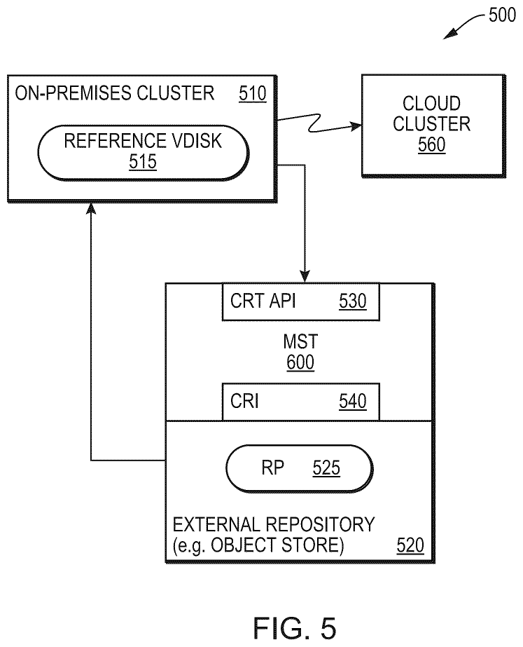

FIG. 5 is a block diagram of an exemplary data replication environment configured for use in various deployments, such as for backup and/or disaster recovery (DR). Illustratively, the environment 500 includes an on-premises cluster 510 (e.g., primary site A) and/or a cloud cluster 560 (secondary site B), as well as MST 600. Each site represents a datacenter embodied as cluster 100 having one or more nodes 110. A category of data (e.g., one or more UVMs 210 and its associated application workload) running on a node 110 at primary site A is designated as a protected entity for failover (failover data) recovery to a secondary site B (e.g., secondary node 110) in the event of failure of primary site A for a DR environment or for failover recovery from an external repository (e.g., object store 520) in the event of a data corruption at primary site A for a backup environment. Although the smart prefetching technique may be applied to the DR environment, the following description is illustratively directed to an exemplary backup environment.

In an embodiment, to facilitate the failover/failback recovery, MST 600 may process a request to determine changes between an incremental snapshot of the failover/failback data generated on the on-premises cluster 510 and a reference vdisk 515 of an external snapshot or recovery point (RP) 525 that is stored on object store 520 of, e.g., cloud storage 166, and indexed by the MST. During failover/failback recovery, only the differences (i.e., determined changes) between the reference vdisk 515 and the RP 525 are pulled (fetched) in accordance with diff-based data seeding of a recovery vdisk. Illustratively, a “changed regions” application programming interface (API), e.g., Changed Region Tracking (CRT) API 530, provided by MST 600 may be employed to identify the differences or “changed regions” between the RP 525 and reference vdisk 515 indexed by the MST. The CRT API 530 requests changed regions information (CRI 540) by specifying the RP 525 and the reference vdisk 515 to optimally fetch only the changed regions. The CRT API 530 may also provide CRI 540 by specifying the RP 525 without a reference, in which case CRI 540 will be returned for only those regions on the RP 525 that were actually written, i.e., including explicitly written zeros.

In an embodiment, the CRT API 530 (e.g., GetChangedRegions) provides metadata for the region that differs between the vdisks. For a baseline data transfer (i.e., without a reference), the CRT API 530 can also provide information about zero/unmapped regions, which avoids calls to the object store 520 to transfer data region contents having zeros so that only on-disk locations that have been written (modified) are fetched. Using the CRT API 530, data may be efficiently seeded from the RP 525 as mapped ranges. That is, diff-based seeding of data may be performed with or without an on-premises reference vdisk 515. For diff-based data seeding without a reference (i.e., baseline data transfer), only the written data contents are fetched from the RP 525. The CRT API 530 provided by MST 600 identifies only those regions of the RP 525 that were written or changed from the reference vdisk 515, thereby eliminating fetching of data from regions that were not changed, i.e., regions of the RP 525 having unmodified data. That is, the MST provides only the latest version of data after fetching the reference vdisk.

In an embodiment, MST 600 is a component for hybrid multi-cloud data backup and restore deployments that provides flexibility to store data in a highly available, resilient, and ubiquitous object store 520. Data services/processes of MST 600 may execute on a computing platform of one or more nodes 100 including, e.g., processor 120, memory 130, and one or more network adapters 150 and storage adapters 140, at any location and is generally “stateless” as all data/metadata are stored on the object store 520. MST 600 also facilitates transferring of a protected entity (e.g., an application) to an on-premises cluster 510 from the cloud in case of a disaster. The object store 520 is illustratively configured to offload large numbers of snapshots due to its following characteristics: (i) cheap storage cost, (ii) high data availability, (iii) highly scalable storage, and (iv) infrequent access of snapshot data, which is usually retrieved in the case of a disaster. It should be noted, however, that snapshots might be stored for a longer time to meet legal and compliance requirements.

In an embodiment, MST 600 utilizes an index data structure for efficient retrieval of data from one of a substantial number of snapshots stored (maintained) in the object store 520. Indexing of the index data structure is configured according to extents of a vdisk defined as contiguous, non-overlapping, variable-length regions of the vdisk generally sized for convenience of object stores in archival storage systems (e.g., Amazon AWS S3 storage services, Google Cloud Storage, Microsoft Azure Blob Storage, and the like). Each snapshot maintained in the object store 520 is associated with a corresponding index data structure and may include incremental changes to a prior snapshot that may reference a prior index data structure associated with the prior snapshot. Illustratively, the index data structure is embodied as a B+ tree with a large branching factor that is configured to translate a logical offset range (address space) of data in a snapshot to a data object address space of the object store hosting (storing) the snapshot data by extent to thereby enable efficient (i.e., bounded time) retrieval of the snapshot data from the object store independent of the number of snapshots.

Although MST 600 is configured to store and retrieve data efficiently from object store 520, the following storage access operations are generally needed to fetch data of a snapshot (e.g., RP 525) for any region: (1) a first storage access operation to fetch index metadata; (2) a second storage access operation to fetch object metadata; and (3) a third storage access operation to fetch object data. In an embodiment, the index metadata may be fetched from a persistent database that includes configuration information about each snapshot and associated data object, such as a pointer to a root of the index data structure (e.g., B+ tree of root, internal, and leaf nodes) for the data object. The object metadata is then fetched from the B+ tree stored in the object store to determine the location of data in an object (e.g., RP) and the object metadata is used to fetch (read) the actual object data from the object store.

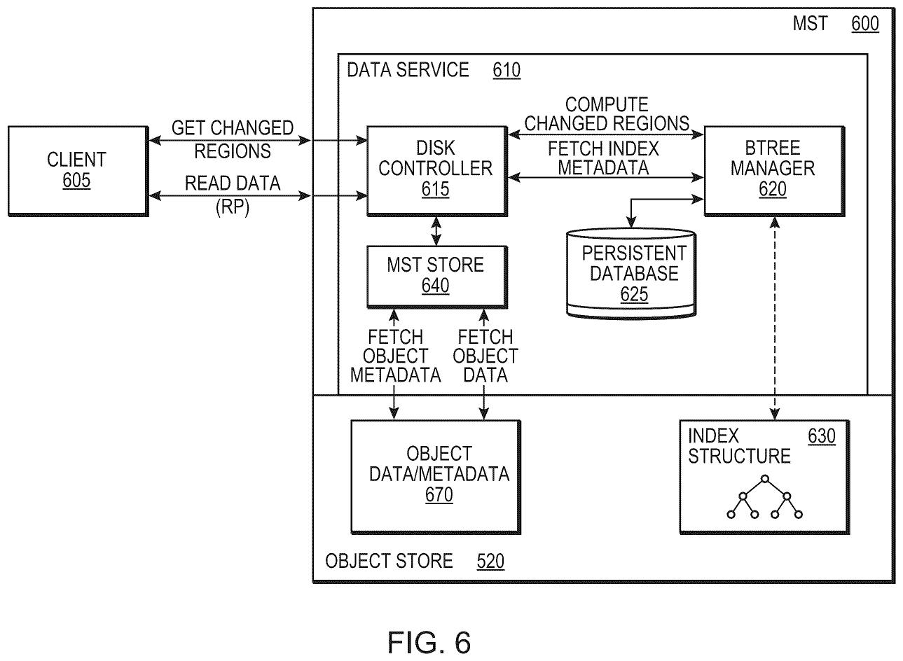

FIG. 6 is a block diagram of an exemplary workflow for fetching data from an object store. Typically, a client 605 (e.g., CVM 300 of on-premises cluster 510) sends a request to a data service 610 of the MST 600 to get changed regions of an RP 525. The request is received by an administrative control service (e.g., disk controller 615) and forwarded to an index (e.g., Btree) manager 620 of MST 600. In an embodiment, the Btree manager 620 provides one or more APIs (e.g., CRT API 530) to compute differences or changes of data for the changed regions. The Btree manager 620 computes the differences (diffs) and the data service 610 returns the changed regions to the client. The client 605 may then send another request to the data service 610 to read the data. In response, the Btree manager 620 fetches the index metadata from a persistent database 625 or, if not found in the persistent database 625, from the object store 520. The index metadata is used to determine object metadata, e.g., an identifier (ID) of an object and an object range (e.g., an offset and a length) of the object, that is fetched by MST store 640 from object data/metadata 670, which co-locates the object data and metadata in an object of the object store 520. The MST store 640 then uses the object metadata to fetch (read) the object data (e.g., from the object data/metadata 670) in the object store 520. The MST store 640 provides the fetched object metadata and object data to the disk controller 615 of the data service 610, which responds to the client 605 with the object data.

As more incremental snapshots of the RP 525 are generated over time, the data and metadata of the RP 525 may become more fragmented. Assume a snapshot of data (e.g., a 1 TB) is generated and replicated as RP 525 for storage as one or more data objects at the object store 520. Subsequently, the RP 525 is restored with throughput of 1 GB/sec and low latency because the data/metadata fragmentation is low. As more snapshots (RPs) are generated, the data/metadata fragmentation increases, which increases the time to restore the RP 525. For a 1 TB RP, the data read time is impacted due to the fragmentation and the recovery time objective (RTO) increases. Index metadata access cost is not an issue because once a few (e.g., internal and/or leaf) nodes from the B+ tree are fetched, those nodes can be temporarily stored in, e.g., a cache and used to serve a large vdisk address space, e.g., a few GBs of vdisk address space. Hence, the cost of index metadata access may be amortized. However, there may be a substantial number (e.g., billions) of objects, each of which can address a few MB of address (currently 8 MB in MST) space. Therefore, fetching of object metadata and object data in-line with read requests can introduce substantial latency and decrease the performance significantly.

The embodiments described herein are directed to a smart prefetching of operations technique configured to prefetch metadata and/or data of objects stored in a repository service, such as MST, associated with a public cloud object store. One or more data objects (e.g., an application executing in a UVM) at a primary site may be designated for backup or failover to a secondary site, e.g., in the event of failure of the primary site in a multi-site data replication environment. Illustratively, smart prefetching logic of the MST is configured to prefetch the object metadata and/or object data from the object store (i.e., in advance of client requests to read the data) to obviate (avoid) or reduce object store accesses when serving subsequent read requests to thereby reduce latency in servicing those subsequent requests. To that end, when storing data to the object store as one or more objects, the data service of MST maintains specific metadata associated with the data of the objects. The technique utilizes the specific metadata to prefetch object metadata and/or object data before receiving subsequent, actual read requests for that data to improve the read latency and throughput when restoring (bringing up) an application as soon as possible. Notably, the technique builds (constructs, amends, or modifies) one or more heuristics pertaining to a range of data/metadata changes, e.g., a “change regions” API, e.g., the CRT API.

To initiate a full or incremental restore of the application (data) replicated as a recovery point (RP 525), a client 605 initially issues the change region API (CRT API 530) request to data service 610 of the MST 600 to compute (determine) changes or differences (diffs) to a data object (e.g., the RP 525) and then fetches the data. In case of a full restore, computing the diffs beforehand helps the client avoid fetching “zeros changed regions” (e.g., regions initialized with zero that may have been overwritten at most once since initialization) from the object store 520. Also, computing the diffs beforehand helps pull only non-zero changed regions (regions with non-zero data that have been overwritten) for an incremental restore. An index (e.g., Btree) manager of MST provides the changed region APIs to compute the diffs with or without metadata. When a compute diff request with metadata is issued, the Btree manager 620 provides the requested metadata such as object identifier (ID) and object range (e.g., offset and length) along with the changed regions.

According to the technique, when client 605 issues a request to MST 600 for only changed regions of one or more objects in RP 525 (i.e., compute diffs without metadata), data service 610 of MST 600 internally translates the changed regions API request to a request to compute the differences with metadata. The translated request is forwarded to the Btree manager 620, which computes the diffs for the changed regions. The data service 610 then returns the changed regions to the client (e.g., offset and length tuples associated with changed data from the object store). Notably, the data service 610 also builds a heuristic (algorithm) using the additional (specific) metadata (e.g., object ID and object range) returned from the Btree manager 620 to predict subsequent access (e.g., read) requests and, thus, fetches the object metadata and object data in advance. Notably, unlike traditional caching techniques that determine cache entry replacement in response to data access requests, the heuristic (algorithm) decides when to fetch object metadata and data based on recent usages and patterns independent of responding to actual data access requests. Further, the object metadata cache may apply to different vdisks to recover from the RP so that multiple read accesses to those different vdisks may be serviced using the prefetched object metadata.

When the client 605 subsequently issues a next request to fetch the data after receiving the changed regions, the data service 610 of MST 600 has already fetched the object metadata and its associated data in advance, which substantially reduces the latency to retrieve (read) the data because there is no inline cost to read the object metadata and object data along with the read request. The smart prefetching technique thus facilitates fast recovery of data by increasing the restore throughput and reducing latency to enable fast instantiation (bringing up) of an application to meet, e.g., DR requirements.

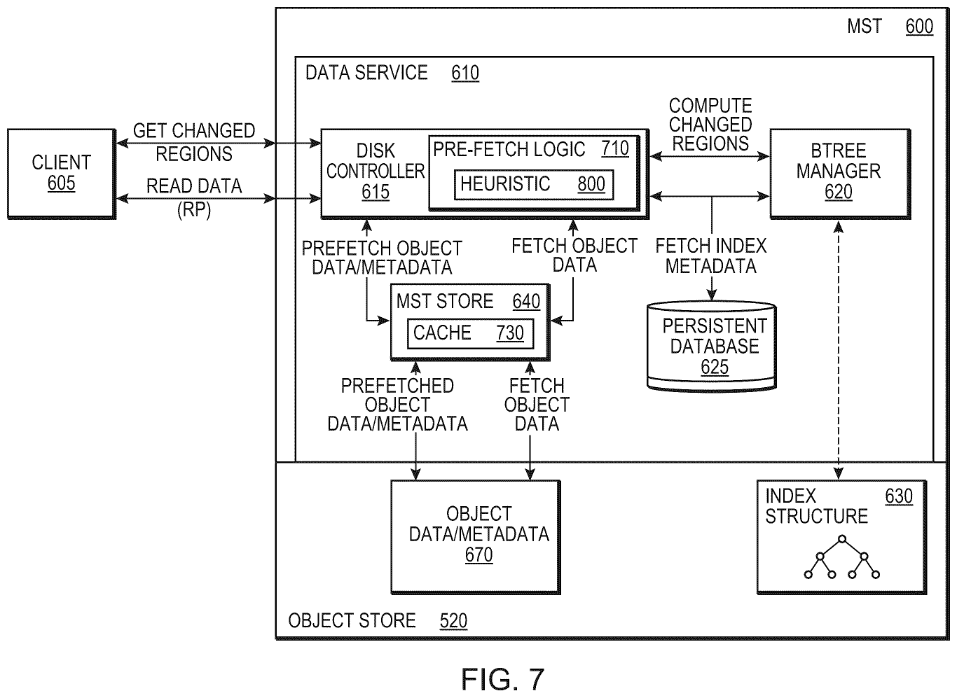

FIG. 7 is a block diagram of an improved workflow for fetching data from an object store in accordance with a smart prefetching of operations technique. Client 605 sends a request to the data service 610 of MST 600 to get changed regions of an RP 525. The request is received by disk controller 615 and forwarded to Btree manager 620 which computes (determines) the differences or changes of data for the changed regions. The data service 610 then returns the changed regions to the client. According to the smart prefetching technique, the Btree manager 620 also fetches the index metadata, e.g., from persistent database 625 or from index data structure 630 in the object store 520 if the index metadata is not resident/found in the database 625. The index metadata is used to determine object metadata, e.g., an ID of an object (RP 525) and an object range (e.g., an offset and a length) of the object, stored in object data/metadata 670 in the object store 520. Prefetch logic 710 of the data service 610 uses the object metadata to issue a request to MST store 640 to prefetch the object metadata from the object data/metadata 670 in the object store 520 based on one or more heuristics 800 and stores the object metadata locally, e.g., in MST store 640. In this manner, technique predicts a need of metadata for servicing subsequent data access requests. The client 605 subsequently sends another request to the data service 610 to read the data. In response, the prefetch logic 710 reads the index metadata and object metadata from the MST store 640 and issues a request to the MST store 640 to fetch the object data (e.g., from object data/metadata 670) in the object store 520. The MST store 640 provides the fetched object data to the disk controller 615 of the data service 610, which then responds to the client 605 with the object data. The smart prefetching of operations technique thus substantially reduces the read latency (e.g., by approximately more than half) because only a single read from the object store is required to service multiple read requests.

Often clients are only interested in fetching changed regions of the RP 525 but not reading data of those changed regions/ranges. That is, client applications often determine whether changes have occurred (e.g., are there changes between two snapshots?) rather than examining the actual changes (i.e., data). In that case, the smart prefetching technique stops (halts) prefetching object metadata (e.g., metadata locating data) to obviate (prevent) consumption of unnecessary I/O operations and computation. The technique also involves calls to the object store 520 to prefetch the object metadata. There may be a limit on the maximum concurrent calls to the object store according to, e.g., storage type. Moreover, the object store calls may conflict with other operations, such as reads and/or writes, to the object store, requiring those operations to wait. To address this issue, the technique constantly checks whether the object metadata being prefetched is accessed. If the metadata is not being accessed, the technique halts prefetching operations. That is, a lack of accesses to metadata implies a lack of change region requests which, in turn, implies an expected lack of future data accesses so that prefetching is unneeded.

To improve the RTO and restore an RP (application) as soon as possible, the smart prefetching of operations technique constructs (builds) one or more heuristics 800 to facilitate prefetching of object metadata and object data of the RP 525 in advance of subsequent (read) requests for the metadata/data. As noted, when retrieving (fetching) data of the RP during restore, MST 600 performs a first storage access (read) operation to retrieve index metadata (B+ tree nodes) from persistent database 625 (or alternatively from object store 520). Reading of the index metadata enables determination of an object from which to read the data. The MST 600 performs a second storage access (read) operation to fetch object metadata from the object store 520 to determine the location of data in an object to enable fetching of object data. A third storage access (read) operation is performed by MST 600 to fetch the actual object data from the object store 520.

In an embodiment, assume client 605 issues a request to MST 600 to get changed regions along with the data. The technique may build a heuristic 800 to fetch specific metadata and data for anticipated upcoming access requests (i.e., predicts those requests) because when a snapshot (e.g., RP 525) is retrieved (pulled) from one or more objects of the object store 520, the data associated with the objects is typically fetched according to the prior changed regions requests. Thus, illustratively, for an object in MST 600 having data for a 1 GB address space, the technique may compute the diff on the 1 GB boundary and obtain all addresses (object ranges) of the data for the changed regions that are expected to be read from the objects as a part of current or future requests. As such, this aspect of the technique reduces the number of read requests for an object.

In another embodiment when prefetching and caching of the entire data of an object is unrealistically large, the entire metadata of the object (being much smaller) instead can be prefetched and cached, e.g., in a portion of local store 720 organized as cache 730. Thus, instead of requiring two (2) object restore (read) operations (e.g., fetch object metadata and fetch object data), the technique requires only one (1) object restore (read) operation (e.g., fetch object data) using the prefetched metadata. This results in a substantial improvement (i.e., reduction) in latency of 50%, as well as a substantial improvement in throughput performance.

The technique described herein is particularly efficient when recovering an RP having large portions being unwritten. For example, assume a RP 525 has 1 TB of data, but only 100 GB data has been written. The majority (90%) of the RP 525 contains non-written, unmodified (zeroed) data (e.g., a zero region). A computation of the differences (compute diffs) of changed regions of the RP returned to the client indicate only 10% of the RP need be read. As such, the client 605 issues a request to read only a small percentage (10%) range of the RP 525 for the data of the changed regions. It is thus efficient for a client to request a compute diff operation from MST 600 prior to an actual read request for changed data of the RP 525.

To take advantage of such efficiencies, in an embodiment, MST 600 is capable of distinguishing between zeroed data and non-zeroed data. Illustratively, for a RP vdisk size of, e.g., 32 TB with only 1 TB of non-zeroed (written) data, a client 605 may issue a get changed regions request (translated to a compute diff API provided by BTree manager 620 of MST 600) to compute the diffs of only 1 TB data (not the entire 32 TB) of the RP 525. In response, MST 600 fetches the index metadata to determine the appropriate object ID and object range of the changed region, followed by the object metadata (offset and length in the object) and finally the actual object data based on the metadata. Notably, returned changed regions in response to the get changed regions request are apportioned between zeroed data (the entire region is zeros) and non-zeroed data (at least some non-zero data) regions.

In an embodiment, the technique may fetch metadata in small batch requests to incrementally build the heuristic when a large number of change regions are encountered to avoid unnecessary prefetching when follow-on read accesses do not occur as is often the case when clients merely probe for changes. For example, assume a heuristic 800 is directed to a client request to compute the changed regions of the RP 525. MST 600 determines there are many (32K) changed regions returned to the client 605. The changed regions may require the client to read object ranges from many (30 K) different objects. Generally, it is not efficient to prefetch metadata for all 30 K objects. Instead, the technique utilizes the heuristic 800 to prefetch the metadata in batches. Illustratively, the heuristic initially issues prefetch operations for metadata and/or data directed to a number (e.g., a few hundred) objects to provide time to determine whether actual read operations for data will follow (occur), i.e., to incrementally build the heuristic. If reads for the data do not occur, the heuristic 800 stops (halts) any further prefetching of metadata and/or data. Here, there is a time-based correlation between a request to compute diffs and a request to read the data of the computed diffs.

Data I/O caching is dependent on the nature of the workload, e.g., sequential v. non-sequential reads. It should be noted that the smart prefetching technique is not related to workload data or serving of primary I/O data. In contrast, the technique is directed to serving snapshot metadata and data differences between snapshots. When a client 605 issues a request to determine the differences between snapshots, the response is not primary I/O data but rather metadata related to changed regions. The request does not result in touching actual data but rather only providing metadata that identifies differences between the snapshots. While computing the differences (diffs), the technique anticipates that soon thereafter the client may read the actual data (blocks) of the computed diff regions of the snapshots. The technique eases the anticipated fetching overhead by prefetching at least certain information (e.g., object metadata) related to the actual data blocks and may also fetch those data blocks.

In an embodiment, prefetching may occur at any level. In accordance with the technique, the heuristic 800 is illustratively directed to smart prefetching of operations that are “heterogeneous” in nature—differing classes of operations such as metadata and data operations, e.g., calling an API (CRT API 530) that is metadata-specific and thereafter using that metadata to perform data read operations related to backup and/or restore workload. This is different from regular data caching of operations that are more “homogeneous” in nature—a same class of operation such as only data accesses, e.g., a series of read operations used to predict a next read operation, and that are related to primary I/O data workload.

Assume a client reads a majority (80%) of data from an object. The heuristic 800 directs prefetching of the entire object because of the predicted behavior of the backup/restore nature of the workload to eventually read the whole object, e.g., partial reads are senseless. Also, if there are many (e.g., approximately 100) vdisks from which data is read, the prefetch logic 710 is configured to detect which vdisks are used to only compute diffs, and which vdisks are used to both compute diffs and read data. Illustratively, for the vdisks that are accessed to only compute diffs, the technique does not prefetch metadata and/or data, because there is no benefit to prefetching metadata for accessing un-requested data. For the vdisks that are accessed to compute diffs and read data, the technique identifies whether the reads are random or denote a pattern based on the constructed heuristic, the latter of which informs prefetching of metadata and/or data.

In an embodiment, the type of request served by the technique is metadata that may not represent a consecutive pattern-based read request, but rather a unique characteristic that may be a temporal disassociation of access to data. That is, the inherent nature of the smart prefetching of operations technique is different from conventional prefetching of operations and the heuristic (algorithm) 800 that applies to the technique is also different than conventional data-type prefetching predictions that follow locality and/or consecutive patterns of accesses or sequences. For example, consider a case of comparatively light operations, wherein a first request is to compute diffs for 8 MB (0-8 MB) of RP 525. At a point in time, a second request is to read 6 MB (0-6 MB range) of data of the RP. The heuristic 800 directs prefetching of the entire 8 MB of data because the technique anticipates (i.e., the heuristic predicts) that the next 2 MB of data will be read and the diff is already computed.

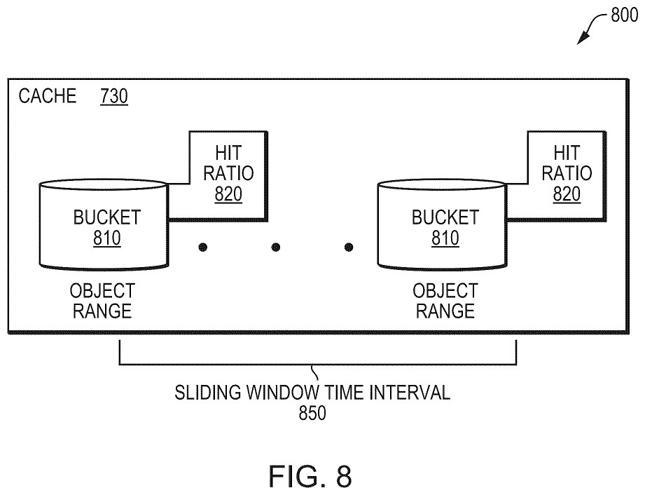

FIG. 8 is a block diagram of an exemplary heuristic constructed by the smart prefetching of operations technique. In an embodiment, the smart prefetching technique creates a plurality of buckets 810 organized within cache 730 for various object ranges of a vdisk. Heuristic “metadata” is associated with each bucket indicating a hit ratio 820 of the bucket 810. An overall sliding window time interval 850 is provided where object ranges (buckets 810) are purged from the cache 730 if there is no (read) activity during the time interval. Yet if there is read activity reflecting (recording) a high hit ratio (exceeds a predetermined threshold) for a particular object range (bucket 810), then the range is maintained (kept) in the cache 730; that is, within the sliding window interval 850, ranges with recorded hit ratios 820 exceeding the threshold are maintained in the cache 730. After a predetermined adjustment period (e.g., 5 mins), the hit ratio 820 is rechecked. If no requests (reads) occur, the ranges are purged from the cache 730. Another object range (bucket 810) of data is loaded into the cache 730 and sliding window progresses to a next time interval for determining the hit ratio 820. The prefetch logic 710 monitors the hit ratios 820 of the cached ranges. If the hit ratio is low (below another threshold) and continues to be low with subsequent object ranges of the vdisk/RP, the logic 710 halts loading of subsequent ranges into the cache 730. However, if the hit ratio is high for an object range (e.g., read request activity exceeds the predetermined hit ratio threshold), the prefetch logic 710 keeps the range in the cache 730 beyond the adjustment period established by the sliding window, i.e., an object range that is frequently accessed (hit) with read requests is not purged and instead is maintained in the cache.

An illustrative example of a heuristic algorithm is as follows:
1. compute diffs for ranges of objects on a vdisk;
2. record when diffs are computed (timestamp);
3. initiate sliding window time interval;
4. record number of read requests to object ranges received during the interval;
5. if no requests (reads) are received during the interval, purge cache of the ranges;
6. if reads are received, but are below a predetermined low threshold, e.g., 10% of ranges, do not prefetch object metadata and/or data because the “hit ratio” is low/small;
7. if the hit ratio exceeds predetermined high threshold, prefetch object metadata;
8. continue prefetching object metadata as the sliding window progresses to determine percentage of reads occurring for object ranges of vdisk and hit ratio on changed regions.

Another example of a heuristic constructed by the technique is directed to a situation where object metadata (ranges) are populated in the cache 730 and there is no space to prefetch any additional object metadata and/or data. Accordingly, the prefetch logic 710 “slows” (decreases frequency of/increases time between) prefetching of operations, especially if pending data access operations using the metadata or data are expected to complete during the time between prefetch operations. That is, if the cache 730 is full and there are no ranges to purge (evict), there is no cache (memory) space (i.e., insufficient free capacity existing in the cache) to load (fill) additional ranges so the prefetch logic 710 “slows down” (increases time between) requests to allow room (space) in the cache to become available (i.e., portions of the cache may become invalidated or evicted during the time between requests). For example, assume there is 100 MB of cache space to store object ranges. Reads may have occurred to some cached ranges but those reads have yet to complete. For any additional compute diff requests received at MST 600, the prefetch logic 710 does not evict those ranges (because prefetching is in progress) to make room for the next ranges of diffs computation.

In an embodiment, the technique may base cache evictions on an expected consumption of the metadata and/or data by the client. For example, if ranges need to be evicted from the cache 730 (because, e.g., cache/memory “footprint” space is limited), the technique evicts those ranges with the highest hit ratios 820 because those ranges are presumed to have been consumed. Illustratively, according to a consumption model of the technique, if a certain number of requests have occurred to an object range, the technique predicts that range will not be hit again and, thus, the range may be evicted from the cache 730, i.e., the technique assumes servicing of read requests has completed for that range of an object. The evicted range may then be placed into one of a plurality of buckets 810 organized as, for example:
(i) a first bucket for ranges with 0 read requests (hit ratio of 0);
(ii) a second bucket for ranges with 0-2 read requests (hit ratio of 0-2); or
(iii) a third bucket for ranges with 2-4 read requests (hit ratio of 2-4).

The buckets 810 with the higher number of read requests (higher hit ratios 820) are considered for removal/eviction from the cache 730 when cache/memory footprint is limited. In an embodiment, access requests may be predicted or bounded based on a ratio of object range size to client read request size. For example, if an object size may be 8 MB (object range of 0-8 MB) and the maximum client read request may be 1 MB (object range) at a time, then 8 read requests is predicted to be the maximum number of reads before the object is consumed, i.e., 8 read requests indicate that the object may be evicted from the cache. Buckets 810 with ranges having the highest number of read requests are purged first in accordance with a most used (MU) eviction policy wherein a read request to the range occurs only once for the object. This “one read request per object” policy is applicable to a backup/restore workload that recovers a RP 525 in a DR environment.

As noted, the smart prefetching technique described herein is quite different from conventional (traditional) I/O data caching. For example, database I/O data caching is based on observing access patterns on data (a trigger) to drive data caching of operations that are, as noted, typically homogeneous (either all metadata accesses or all data accesses) in nature. In contrast, the trigger for the technique described herein is NOT data accesses but rather a type of metadata operation, e.g., diff computation, which is leveraged to perform caching for a different subsequent operation (e.g., metadata/data access). In addition, the technique employs a consumption-based MU eviction policy that is illustratively applicable to restoration of a RP 525, i.e., once data is read, the access request is completed, reading of data is not needed again, and the range can be evicted. Further, the technique decides when to fetch object metadata and/or data based on heuristics independent of responding to actual data access requests.

Advantageously, the smart prefetching technique described herein reduces I/O latency and improves I/O throughput which, in turn, facilitates reduction in RTO. Object stores typically have outstanding limits on read (GET) and store (PUT) requests. If many read requests are issued in parallel, the object store 520 may become overloaded and return errors to reduce the rate of the requests below an I/O rate limit. As such, the technique “time shifts” expected requests to smooth out the rate of actual requests to the object store by emphasizing fetching of object metadata and object data in advance so that the I/O rate reduction may evenly distribute the load over a period of time to handle burst read requests efficiently. The technique thus reduces the number of read requests for an object by retrieving all object ranges in advance that can be read as a part of current or future requests.

Notably, the technique provides several advantages, such as substantial reduction in latency in data read requests, substantial reduction in cost every time the read request is made to public cloud object storage, and faster data restoration or recovery during failover or disaster scenarios. The smart prefetching technique thus speeds up data restore by fetching object metadata and data in advance without extra cost. The technique also benefits accessing data for passive statistics gathering and analytics. The heuristic (algorithm) decides when to fetch object metadata and data based on recent use and patterns. Moreover, the technique dynamically decides whether to fetch, e.g., in advance, object metadata and object data or just object metadata depending on the current load in the system and other heuristics. As such, the technique reduces the disaster recovery time objective by improving restore throughput.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving a request at a data service to provide a changed region for a snapshot of a recovery point stored in a repository service executing on a computing platform;
in response to receiving the changed region request, computing differences of the changed region for the snapshot based on metadata stored at the repository service and associated with stored object data of the recovery point;
replying to the changed region request with the computed differences;
constructing a heuristic based on the changed region and computed differences to predict subsequent access requests associated with the changed region; and
prefetching metadata from the repository service used to retrieve the object data for servicing the predicted subsequent access requests according to the heuristic.

2. The method of claim 1, further comprising prefetching the object data for servicing the predicted subsequent access requests according to the constructed heuristic.

3. The method of claim 1, wherein constructing the heuristic further comprises:
recording a hit ratio of one or more requests to access the computed differences of the snapshot per changed region; and
prefetching the object data for servicing the predicted subsequent access requests when a corresponding hit ratio of a changed region exceeds a predefined threshold.

4. The method of claim 1, further comprising avoiding prefetching the object data for servicing the predicted subsequent access requests when insufficient free capacity exists in a cache at the data service.

5. The method of claim 1, wherein prefetching the metadata from the repository service occurs when a recorded number of access requests for the computed differences of the snapshot of a corresponding changed region exceeds a threshold during a sliding window time interval.

6. The method of claim 1, wherein prefetching the metadata from the repository service occurs in batches according to a number of changed regions determined from the computed differences of the snapshot.

7. The method of claim 1, further comprising:
recording a number of requests to compute differences of the snapshot per changed region during a sliding window time interval; and
purging a cache at the data service storing the prefetched metadata corresponding to changed regions for which the number of access requests for the computed differences is zero during the sliding window time interval.

8. The method of claim 1, further comprising prefetching the object data according to the changed region computed from the differences of the snapshot for servicing the predicted si subsequent access requests, and wherein the access requests are serviced from the object data according to a portion of the changed region less than a whole.

9. The method of claim 1, further comprising increasing a time between prefetches of the metadata from the repository service in response to insufficient free capacity existing in a cache at the data service.

10. The method of claim 1, wherein constructing the heuristic further comprises:
determining an expected client consumption of the object data according to changed regions by grouping changed regions according to a recorded hit ratio of a number of access requests to the computed differences of the snapshot per changed region; and
evicting the prefetched metadata from a cache at the data service having a highest hit ratio of access requests according to a most used eviction policy.

11. A non-transitory computer readable medium including program instructions for execution on a processor, the program instructions configured to:
receive a request at a data service to provide a changed region for a snapshot of a recovery point stored in a repository service executing on a computing platform;
in response to receiving the changed region request, compute differences of the changed region for the snapshot based on metadata stored at the repository service and associated with stored object data of the recovery point;
reply to the changed region request with the computed differences;
construct a heuristic based on the changed region and computed differences to predict subsequent access requests associated with the changed region; and
prefetch metadata from the repository service used to retrieve the object data for servicing the predicted subsequent access requests according to the heuristic.

12. The non-transitory computer readable medium of claim 11 wherein the program instructions are further configured to prefetch the object data for servicing the predicted subsequent access requests according to the constructed heuristic.

13. The non-transitory computer readable medium of claim 11, wherein the program instructions configured to construct the heuristic are further configured to:
record a hit ratio of one or more requests to access the computed differences of the snapshot per changed region; and
prefetch the object data for servicing the predicted subsequent access requests when a corresponding hit ratio of a changed region exceeds a predefined threshold.

14. The non-transitory computer readable medium of claim 11 wherein the program instructions are further configured to avoid prefetching the object data for servicing the predicted subsequent access requests when insufficient free capacity exists in a cache at the data service.

15. The non-transitory computer readable medium of claim 11 wherein the program instructions configured to prefetch the metadata from the repository service occurs when a recorded number of access requests for the computed differences of the snapshot of a corresponding changed region exceeds a threshold during a sliding window time interval.

16. The non-transitory computer readable medium of claim 11 wherein the program instructions configured to prefetch the metadata from the repository service occurs in batches according to a number of changed regions determined from the computed differences of the snapshot.

17. The non-transitory computer readable medium of claim 11 wherein the program instructions are further configured to:
record a number of requests to compute differences of the snapshot per changed region during a sliding window time interval; and
purge a cache at the data service storing the prefetched metadata corresponding to changed regions for which the number of access requests for the computed differences is zero during the sliding us window time interval.

18. The non-transitory computer readable medium of claim 11 wherein the program instructions are further configured to prefetch the object data according to the changed region computed from the differences of the snapshot for servicing the predicted subsequent access requests, and wherein the access requests are serviced from the object data according to a portion of the changed region less than a whole.

19. The non-transitory computer readable medium of claim 11 wherein the program instructions are further configured to increase a time between prefetches of the metadata from the repository service in response to insufficient free capacity existing in a cache at the data service.

20. The non-transitory computer readable medium of claim 11, wherein the program instructions configured to construct the heuristic are further configured to:
determine an expected client consumption of the object data according to changed regions by grouping changed regions according to a recorded hit ratio of a number of access requests to the computed differences of the snapshot per changed region; and
evict the prefetched metadata from a cache at the data service having a highest hit ratio of access requests according to a most used eviction policy.

21. An apparatus comprising:
a multi-cloud snapshot technology (MST) service configured to execute on a processor of a computing platform, the processor further configured to execute program instructions to,
receive a request at a data service of the MST service to provide a changed region for a snapshot of a recovery point stored in an object store associated with the MST service;
in response to receiving the changed region request, compute differences of the changed region for the snapshot based on metadata associated with stored object data of the recovery point;
reply to the changed region request with the computed differences;
construct a heuristic based on the changed region and computed differences to predict subsequent access requests associated with the changed region; and
prefetch metadata from the MST service used to retrieve the object data for servicing the predicted subsequent access requests according to the heuristic.

22. The apparatus of claim 21 wherein the program instructions further include program instructions to prefetch the object data for servicing the predicted subsequent access requests according to the constructed heuristic.

23. The apparatus of claim 21, wherein the program instructions to construct the heuristic further include program instructions to:
record a hit ratio of one or more requests to access the computed differences of the snapshot per changed region; and
prefetch the object data for servicing the predicted subsequent access requests when a corresponding hit ratio of a changed region exceeds a predefined threshold.

24. The apparatus of claim 21 wherein the program instructions further include program instructions to avoid prefetching the object data for servicing the predicted subsequent access requests when insufficient free capacity exists in a cache at the data service.

25. The apparatus of claim 21 wherein the program instructions to prefetch the metadata from the MST service occurs when a recorded number of access requests for the computed differences of the snapshot of a corresponding changed region exceeds a threshold during a sliding window time interval.

26. The apparatus of claim 21 wherein the program instructions to prefetch the metadata from the MST service occurs in batches according to a number of changed regions determined from the computed differences of the snapshot.

27. The apparatus of claim 21 wherein the program instructions further include program instructions to:
record a number of requests to compute differences of the snapshot per changed region during a sliding window time interval; and
purge a cache at the data service storing the prefetched metadata corresponding to changed regions for which the number of access requests for the computed differences is zero during the sliding window time interval.

28. The apparatus of claim 21 wherein the program instructions further include program instructions to prefetch the object data according to the changed region computed from the differences of the snapshot for servicing the predicted subsequent access requests, and wherein the access requests are serviced from the object data according to a portion of the changed region less than a whole.

29. The apparatus of claim 21 wherein the program instructions further include program instructions to increase a time between prefetches of the metadata from the MST service in response to insufficient free capacity existing in a cache at the data service.

30. The apparatus of claim 21, wherein the program instructions to construct the heuristic further include program instructions to:
determine an expected client consumption of the object data according to changed regions by grouping changed regions according to a recorded hit ratio of a number of access requests to the computed differences of the snapshot per changed region; and
evict the prefetched metadata from a cache at the data service having a highest hit ratio of access requests according to a most used eviction policy.
